(19) United States
(12) Patent Application Publication
(10) Pub. No.: US 2007/0095846 A1
(43) Pub. Date: May 3, 2007

(54) Method and device for utilizing a single use disposable sippie lid

(76) Inventors: Amy M. Goecke, Spencerville, OH (US); Steven J. Goecke, Spencerville, OH (US)

Correspondence Address: Raymond M. Galasso;Galasso & Associates LP, P.O. Box 26503, Austin, TX, 78755-0503, US

(21) Appl. No.: 11/251,235

(22) Filed: Oct. 15, 2005

(51) Int. Cl. B65D 41/18; A47G 19/22; G06F 17/00

(52) U.S. Cl. 220/780; 220/717; 220/714; 220/709; 705/500

(57) ABSTRACT

A single-use disposable sippie lid for use by the food and beverage industry to be integrated with a disposable beverage container. The single-use disposable sippie lid includes a spout extending from the main body of the lid. The spout being perforated and tapered to enable a child to drink from the beverage container. The brim of the lid extends down to securely mate the lid with the beverage container to inhibit spilling when the beverage container is tipped for drinking. A drinking straw access port is also integrated onto the main body of the lid, to permit the user to use either a standard straw or use the spout.

### FIELD OF THE INVENTION

The present invention relates to disposable lids for beverage containers, and more specifically but not by way of limitation a disposable spill resistant sippie lid for disposable beverage containers, such as those sold in fast-food restaurants.

### BACKGROUND

Traveling with children, especially toddlers can be a very demanding task. Parents do everything possible to minimize spills and messes that occur in the car. However, it is the nature of children to tip beverages and drinks when attempting to consume them, even if a straw is inserted into the beverage. With typical beverage containers currently being used by restaurants, such as in the drive-thrus of fast food restaurants, the cups and lids are designed to use straws and are not designed to be tipped forward. Therefore, as many children try to drink through the straws, they tip the beverage container and inevitably spill the beverage on both themselves and on the seats and floor of the vehicle.

Another problem that exists with disposable lids currently being used by restaurants and beverage centers, is that the thickness of the lid is inadequate to prevent children from easily chewing through the lid.

Accordingly there is a need for a disposable single-use lid that that can be integrated with existing beverage containers that is spill resistant and will also facilitate the consumption of a beverage by those who need assistance, such as small children.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a side view of an embodiment of a lid disposed on a typical beverage container in accordance with the principles of the present invention;

FIG. 2 illustrates an exploded side view of the embodiment of the present invention as similarly shown in FIG. 1;

FIG. 3 illustrates a top view of an alternative embodiment of the present invention;

FIG. 4 illustrates a top view of yet another embodiment of the present invention;

FIG. 5 is a block diagram illustrating a method for implementing the present invention; and

FIG. 6 is a block diagram illustrating in more detail parts of the method for implementing the present invention illustrated in FIG. 5.

### DETAILED DESCRIPTION

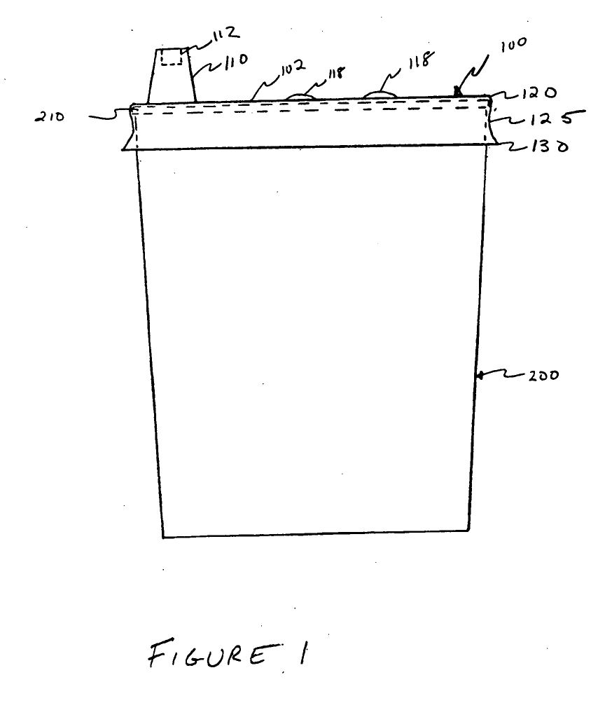

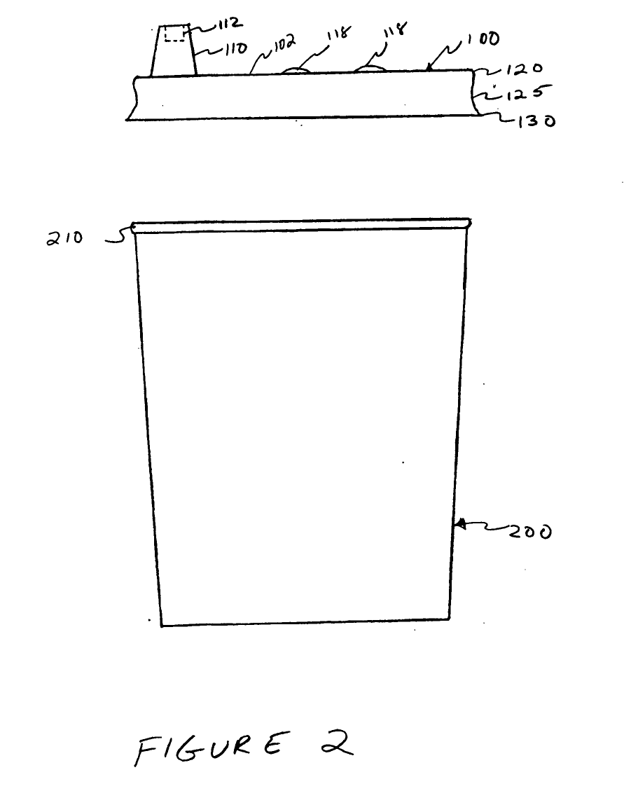

Referring now to the drawings submitted herewith, wherein various elements depicted are not necessarily drawn to scale, and in particular FIGS. 1 and 2 there is illustrated a preferred embodiment of the present invention including a disposable single-use lid 100 and a beverage container 200. As illustrated lid 100 includes a generally planar disk shaped top 102, a tapered spout 110 and beverage indicators 118. Spout 110 has a recessed portion 112 through which holes extend permitting beverages to exit spout 110. Recessed portion 112 minimizes the amount of liquid that can spill through spout 110. It is contemplated that a variety of number, size and types of holes can be integrated into the recessed portion 112, such as, but not limited to holes of graduated diameters, holes of equal diameters, and slits. It is also contemplated that the shape and size of spout 110 could be varied to accommodate a users preference.

Lid 100 further includes circlet rim 120 that extends around the perimeter of lid 100. Extending from rim 120 in an arcuate downward manner is a brim 125 with the bottom portion 130 of brim 125 having a diameter greater than the diameter of rim 120. The arcuate shape of brim 125 not only helps to secure lid 100 to beverage container 200 to prevent leaking but also gives additional support and stability to beverage container 200 which increases the amount of force required to crush beverage container 200 when lid 100 is applied.

Beverage container 200 is a typical beverage container utilized in the standard food industry, and can be manufactured from various materials, such as paper and plastic.

As illustrated in FIG. 1, when lid 100 is placed upon beverage container 200, the lip 210 of beverage container 200 communicates with the underside of rim 120, and the arcuate shape of brim 125 engages the sides of beverage container 200, thereby increasing the stability of beverage container 200. Good results have been achieved by making the length of brim 125 at least ¼ inch in length, although it is contemplated that the length can be varied base on a number of factors, such as the thickness and size of the lid 100, as well as the particular preference of a user.

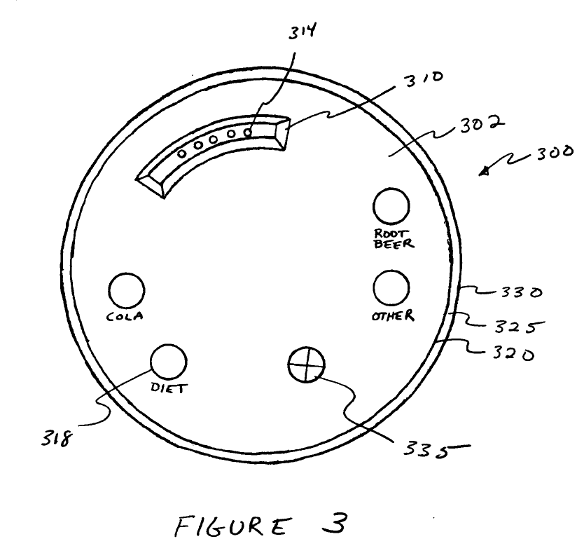

Referring now to FIG. 3, there is illustrated the top view of an alternative embodiment of a disposable single-use lid 300. Lid 300 includes a generally planar disk shaped top 302, and a tapered spout 310 with holes 314 extending through for facilitating the drinking of liquid. Similar to the lid disclosed in FIGS. 1 and 2, lid 300 includes a rim 320 with a brim 325 extending therefrom in a generally arcuate shape with the bottom portion 330 of the brim 325 having a diameter greater that the diameter of rim 320. The arcuate shape of brim 325 helps to secure lid 300 to a beverage container and additionally gives added support and stability the beverage container upon which it is placed. This increases the amount of force required to crush the beverage container, thereby inhibiting spillage. It is contemplated that lid 300 mates with a beverage container similarly to that described herein above with reference to the embodiment disclosed in FIGS. 1 and 2.

As further illustrated in FIG. 3, lid 300 includes beverage indicators 318 and a straw receptacle 335. Beverage indicators 318 are bubble in shape and are depressed to indicate the contents of the liquid being supplied. Straw receptacle 335 is generally a circular shape with cross-scores facilitating the easy insertion of a straw through lid 300. As can be appreciated by one skilled in the art, a big advantage of the embodiment of lid 300 is because of both a spout 310 and a straw receptacle 335, a single lid need only be stocked by the food industry, such, for example, a drink that is to be delivered to target user that is a child, the target user has the option of either using the spout from which to drink, or could insert a straw through straw receptacle 335. This would eliminate the need for the food industry to stock multiple format lids.

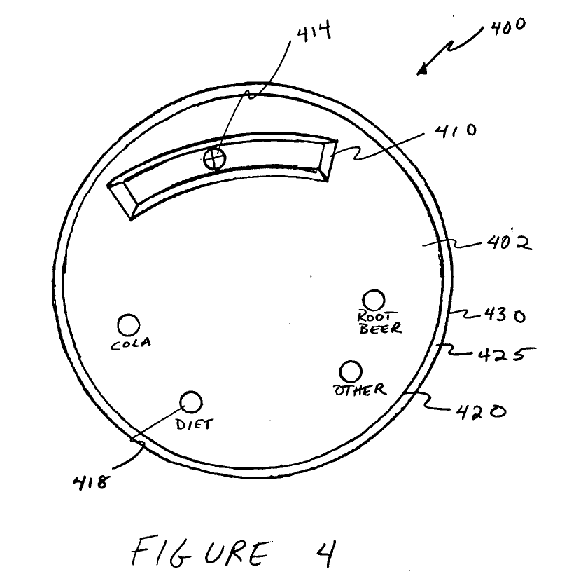

Referring now to FIG. 4, there is illustrated the top view of another alternative embodiment of a disposable single-use lid 400. Lid 400 includes a generally planar disk shaped top 402, and a tapered spout 410 with a liquid access port 314 extending through for facilitating the drinking of liquid. Similar to the lid disclosed in FIGS. 1 and 2, lid 400 includes a rim 420 with a brim 425 extending therefrom in a generally arcuate shape with the bottom portion 430 of the brim 425 having a diameter greater that the diameter of rim 420. The arcuate shape of brim 425 helps to secure lid 400 to a beverage container and additionally gives added support and stability the beverage container upon which it is placed. This increases the amount of force required to crush the beverage container, thereby inhibiting spillage. It is contemplated that lid 400 mates with a beverage container similarly to that described herein above with reference to the embodiment disclosed in FIGS. 1 and 2.

As further illustrated in FIG. 4, lid 400 includes beverage indicators 418. Beverage indicators 318 are bubble in shape and are depressed to indicate the contents of the liquid being supplied. Liquid access port 414 is generally a circular shape with cross-scores facilitating either the easy insertion of a straw through lid 400 or can be breached to facilitate the access of liquid through spout 410 without a straw and in a manner of utilizing a standard sippie spout. As can be appreciated by one skilled in the art, a big advantage of the embodiment of lid 400 is because of liquid access port 414 of spout 410 is designed to operate as either a straw receptacle or to facilitate the use of spout 410 as a sippie spout, a single lid need only be stocked by the food industry, such, for example, a drink that is to be delivered to target user that is a child, the target user has the option of either using the spout from which to drink, or could insert a straw through liquid access port 414. This would eliminate the need for the food industry to stock multiple format lids.

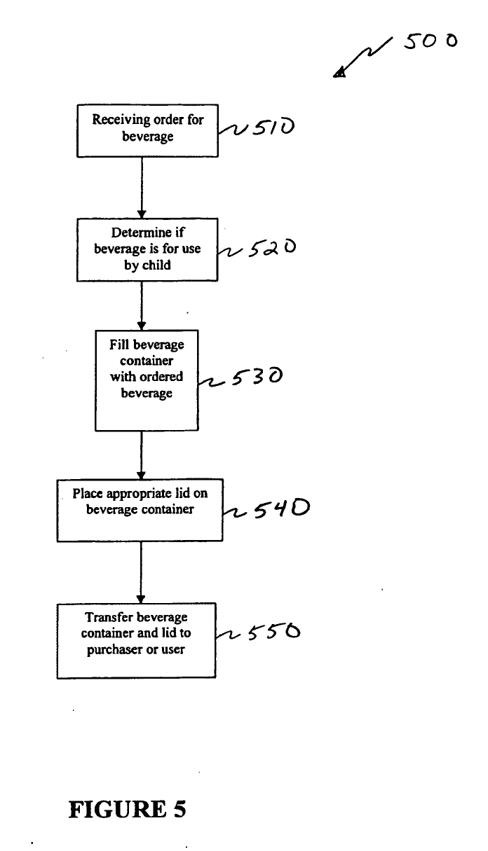

Referring to FIG. 5, there is illustrated a method for 500 for a food or beverage facility implementing a single use disposable sippie lid as shown and described herein. As illustrated in block 510, a facility will receive an order that includes an order for a beverage. Block 520 indicates that a determination is then made as to whether the target consumer of the ordered beverage needs a standard single-use disposable lid or a single-use disposable sippie lid. Block 530 indicates that the beverage container is then filled with the ordered beverage. Subsequent to the filling of the beverage container with a beverage, as indicated by block 540, the appropriate lid, as determined in block 520, is then placed on the beverage container. Then, as indicated by block 550, the beverage container with the appropriate lid is then transferred to the target user.

Regarding the method described and illustrated in FIG. 5, it is contemplated that the steps do not need to occur in the described ordered. For example, but not by way of limitation, in some food/beverage facilities, the target user fills their own beverage, in such a case block 550 would occur between blocks 520 and 530.

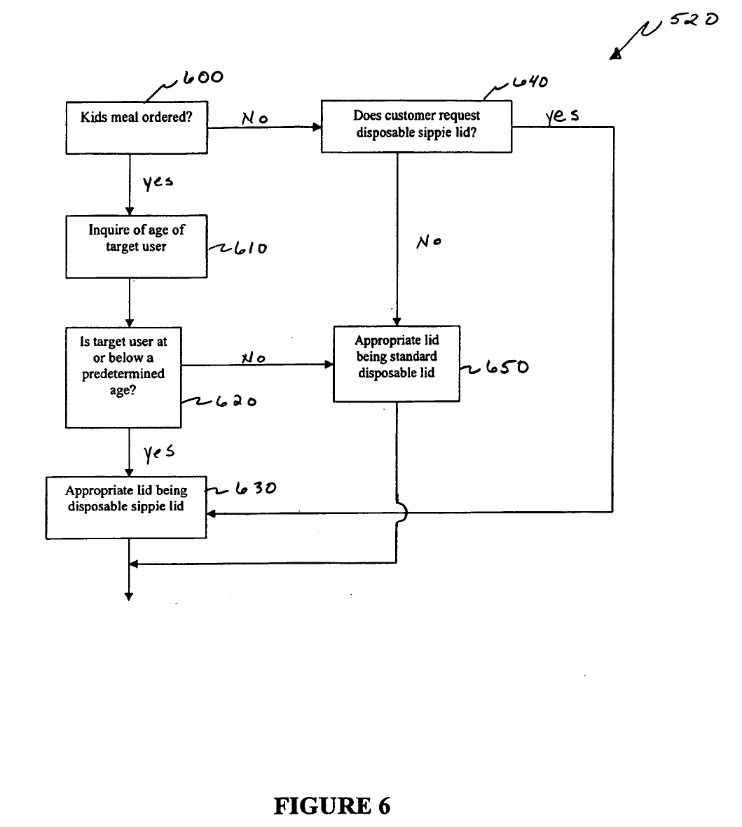

Referring to FIG. 6, there is illustrated a more detailed method for block 520 of FIG. 5 wherein a determination is made as to the type of lid the target consumer of the ordered beverage needs. As illustrated in FIG. 6, block 600 indicates that a determination is made as to whether a kids/child's meal has been ordered. If the a the result of block 600 is in the positive, the ‘yes’ arrow is followed to block 610 wherein an inquiry of the age of the target consumer of the beverage is made. Then, as indicated by block 620, if the age of the target consumer of the beverage falls within a predetermined range, such as if the child is a toddler, the ‘yes’ arrow is followed to block 630 and the appropriate lid is identified as being a single-use disposable sippie lid, as described herein. If, in block 620, the age of the target consumer falls outside the predetermined range, the ‘no’ arrow if followed to block 650. In block 650, the appropriated lid is identified as being a standard lid.

Referring again to block 600, if the determination is made that a kids/child's meal has not been ordered, the ‘no’ arrow is followed to block 640. As indicated in block 640 if the customer requests a single-use disposable sippie lid, the ‘yes’ arrow if followed to block 630, and the appropriate lid is identified as being a single-use disposable sippie lid, as described herein. If the customer does not request a single-use disposable sippie lid, the ‘no’ arrow if followed to block 650, and the appropriate lid is identified as being a standard lid.

As can be appreciated, it is contemplated to be within the scope of this invention various steps could be used. For example, but not by way of limitation, if a single-use disposable lid, such as illustrated in FIGS. 3 and 4 were being implemented, blocks 610 and 620 could be eliminated, such that if a kids/child's meal is ordered, the appropriate lid would always be identified as a single-use disposable sippie lid.

It is contemplated that each of the embodiments of lids described herein in accordance with the present invention can be manufactured of standard food quality molded plastic. The shapes and sizes of the lids can be varied to correspond to the shape of the desired beverage container to which the lid will be mated. It is further contemplated that various colors and patters could also be integrated with the lids to match a particular request of a user.

It is further contemplated that the thickness of the materials making up the spouts would be of sufficient thickness as to inhibit a user from chewing through or biting off the spout from the rest of the lid. Additionally it is contemplated that the shapes and sizes of the spouts illustrated herein could be varied to accommodate various target users.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the sprit and scope of the appended claims.

What is claimed is:

1. A single-use disposable lid comprising:
a top, said top being generally planar and generally disk shape;
a spout integrated with said top, said spout extending from said top, said spout including a perforated portion for permitting liquid for passing through said spout;
a brim integrated with said top, said brim being arcuate in shape and extending from said top; and
a straw receptacle receptacle configured to permit a straw to breach said top.

2. The single-use disposable lid as recited in claim 1, wherein said spout has a first end adjacent said perforated portion, said first end having a portion recessed into said spout.

3. The single-use disposable lid as recited in claim 1, wherein said top having a diameter and said brim having diameter, wherein said diameter of said brim being greater that said diameter of said top.

4. The single-use disposable lid as recited in claim 1, wherein said straw receptacle being generally circular, with a first score traversing said straw receptacle and a second score traversing said straw receptacle.

5. The single-use disposable lid as recited in claim 1, wherein said straw receptacle is positioned on said top.

6. The single-use disposable lid as recited in claim 1, wherein said straw receptacle is positioned on said spout.

7. The single-use disposable lid as recited in claim 1, wherein said top having a thickness, and said spout having a thickness, and further wherein said thickness of said spout being at least twice said thickness of said top.

8. The single-use disposable lid as recited in claim 1, wherein said brim extends at least a ¼ of an inch from said top.

9. A single-use disposable lid for placement on a beverage container, comprising:
a top, said top being generally planar and generally disk shape;
a spout integrated with said top, said spout extending from said top, said spout including a perforated portion for permitting liquid for passing through said spout;
a brim integrated with said top, said brim being arcuate in shape and extending from said top, said brim for engaging the beverage container when the single-use disposable lid in placed thereon; and
a straw receptacle receptacle configured to permit a straw to breach said top.

10. The single-use disposable lid as recited in claim 9, wherein said spout has a first end adjacent said perforated portion, said first end having a portion recessed into said spout.

11. The single-use disposable lid as recited in claim 9, wherein said top having a diameter and said brim having diameter, wherein said diameter of said brim being greater that said diameter of said top.

12. The single-use disposable lid as recited in claim 11, wherein said straw receptacle being generally circular, with a first score traversing said straw receptacle and a second score traversing said straw receptacle.

13. The single-use disposable lid as recited in claim 12, wherein said straw receptacle is positioned on said top.

14. The single-use disposable lid as recited in claim 12, wherein said straw receptacle is positioned on said spout.

15. The single-use disposable lid as recited in claim 12, wherein said top having a thickness, and said spout having a thickness, and further wherein said thickness of said spout being at least twice said thickness of said top.

16. A business method for one of at least a food establishment and a drink establishment for utilizing a single-use disposable sippie lid, comprising:
receiving an order for a beverage;
making a determination if the target user of the ordered beverage desires the single-use disposable sippie lid;
filling a beverage container with a beverage; and
if the determination is made that the target user of the ordered beverage desires the single-use disposable sippie lid, placing the single-use disposable sippie lid on the beverage container.

17. The business method as recited in claim 16, wherein said step of making a determination further includes the step of making a determination if a meal targeted for a child has been ordered.

18. The business method as recited in claim 17, and further including the step of, if the determination is made that a meal targeted for a child has been ordered, making the determination that the target user of the ordered beverage desires the single-use disposable sippie lid.

19. The business method as recited in claim 16, wherein the single-use disposable sippie lid includes a top, said top being generally planar and generally disk shape;
a spout integrated with said top, said spout extending from said top, said spout including a perforated portion for permitting liquid for passing through said spout;
a brim integrated with said top, said brim being arcuate in shape and extending from said top, said brim for engaging the beverage container when the single-use disposable lid in placed thereon; and
a straw receptacle receptacle configured to permit a straw to breach said top.

20. The business method as recited in claim 19, wherein the single-use disposable sippie lied further includes said straw receptacle being generally circular, with a first score traversing said straw receptacle and a second score traversing said straw receptacle and further.
